(19) United States
(12) Patent Application Publication
(10) Pub. No.: US 2002/0169679 A1
(43) Pub. Date: Nov. 14, 2002

(54) Aggregation engine for an electronic commerce system

(76) Inventor: Peter J. Neumayer, Sunnyvale, CA (US)

Correspondence Address: Timothy F. Loomis, Law Offices of Timothy F. Loomis, 2932 Hagen Drive, Plano, TX, 75025, US

(21) Appl. No.: 09/851,644

(22) Filed: May 9, 2001

(51) Int. Cl. G06F 17/60

(52) U.S. Cl. 705/26

(57) ABSTRACT

An aggregation engine for use in electronic commerce systems, such as an enterprise procurement system or an electronic marketplace, that automatically aggregates buyer demands according to an aggregation rule so as to enable the creation of fewer purchase orders and to take advantage of bulk buying power.

### FIELD OF THE INVENTION

This invention relates to providing an aggregation engine for use with electronic commerce systems, such as electronic procurement systems and electronic marketplaces, that assists in the aggregation of buyer demands according to an aggregation rule so as to enable the creation of fewer purchase orders and to take advantage of bulk buying power.

### BACKGROUND OF THE INVENTION

Recently enterprise electronic procurement systems and electronic marketplaces have been developed to streamline electronic commerce and the purchasing process. An electronic procurement system automates much of the purchasing process for a business, such as the creation and tracking of purchase orders. An electronic marketplace facilitates electronic commerce among companies or business units.

With such systems, however, there can be inefficiencies. For example, a large business may have many demands for similar or identical products originating in different groups within the business simultaneously. When this occurs, separate purchase orders for the products may be created. The seller will then have to process each of the separate purchase orders, access inventory each time, arrange for shipping each time, etc. That situation is inefficient and creates much more work for the seller. Because of these inefficiencies, prices are usually higher per item for small volume purchase orders than for high volume purchase orders. Thus, although the buyer may be purchasing larger quantities of product from a seller, he may not take advantage of volume discounts because the buyer is utilizing separate purchase orders.

The same situation is true of multiple unrelated small businesses. If these businesses generate separate purchase orders, they cannot avail themselves of the volume discounts that may be available if they were to combine alike purchases with other companies into a single purchase order.

### SUMMARY OF THE INVENTION

An embodiment of the present invention provides an aggregation engine for an electronic commerce system that aggregates demands of the buyer according to an aggregation rule.

Another embodiment of the present invention provides an aggregation engine for an electronic commerce system that reduces the number of purchase orders issued and enables the buyer(s) to take advantage of seller volume discounts

As such, it is an object of the present invention to permit an electronic commerce system to aggregate demands according to an aggregation rule.

It is a further object of the present invention to permit an electronic commerce system to reduce the number of purchase orders issued by aggregating demands so as to take advantage of volume discounts offered by sellers.

It is a further object of the present invention to improve the seller's efficiency through aggregating demands on an electronic commerce system.

### BRIEF DESCRIPTION OF THE DRAWINGS

FIG. 1 is a block diagram of an aggregation engine according to an embodiment of the present invention.

FIG. 2 is a flow chart diagram of the process undertaken by an aggregation engine according to an embodiment of the present invention.

FIG. 3 is a flow chart diagram of a process of creating purchase orders using an aggregation engine according to an embodiment of the present invention.

FIG. 4 is a flow chart diagram of a process of using an aggregation engine along with a demand aggregation application according to an embodiment of the present invention.

FIG. 5 is a flow chart diagram of a process of using an aggregation engine with a plurality of systems inputting demands to the aggregation engine according to an embodiment of the present invention.

FIG. 6 is a flow chart diagram of a process of using an aggregation engine to assist in creating groups of demands when the demands are manually entered according to an embodiment of the present invention.

### DESCRIPTION OF THE PREFERRED EMBODIMENTS

The present invention will be better understood by reference to the accompanying drawings.

In a procurement system such as Enterprise Buyer Professional by SAPMarkets, Inc., users can create shopping baskets that are used in order to create purchase orders. Different users, however, may create similar shopping baskets for the same or similar products. Instead of creating one purchase order for each shopping basket that may exist, an aggregation engine according to an embodiment of the present invention can identify similar shopping baskets according to a flexible user-defined aggregation rule. These shopping baskets are then grouped together and are identified by an additional ID. This additional ID can be used to select shopping basket items for transfer to the purchase order creation process either automatically or manually.

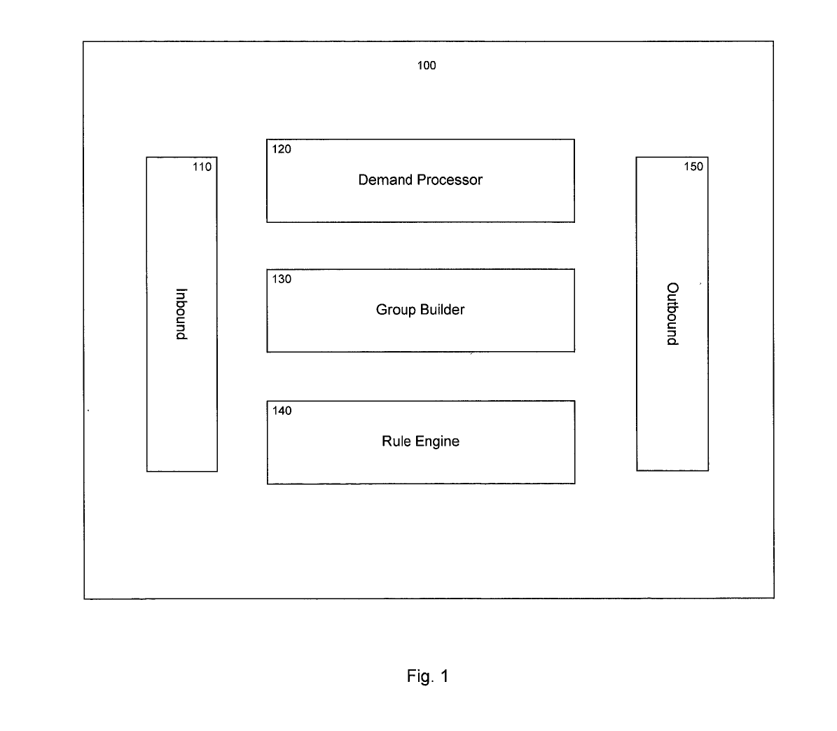

An embodiment of the present invention is depicted in FIG. 1. Referring to that figure, aggregation engine 100 is shown. Preferably, aggregation engine 100 is a Java application that resides on an electronic commerce system, such as an electronic procurement system or an electronic marketplace. Aggregation engine 100 groups given demands according to a defined aggregation rule. As used herein, a demand is an expression of a need, which contains a product or service description or marketplace catalog reference and additionally a quantity, unit, delivery date and maybe even a maximum price and currency.

Aggregation engine 100 contains several components. One such component is an inbound interface 110. Inbound interface 110 receives the demands to be grouped. Preferably, the demands are received in an XML-based format. A validation process is done against the aggregation rule to ensure that each demand provides at least those fields that are defined in the aggregation rule.

Inbound interface 110 also receives controlling parameters, such as which aggregation rule should be used in the grouping, and it initializes the aggregation process. Preferably, these controlling parameters that are received are XML-based and are included in every aggregation engine call. This interface could also be used group inbound data into a set of predetermined groups.

Inbound interface 110 preferably provides synchronous and asynchronous access to aggregation engine 100. Synchronous access may be provided through RMI, EJB and HTTP layers so that clients can access aggregation engine 100 as an RMI server, EJB Session Bean or using HTTP protocol. Preferably, asynchronous access is provided through message-based middleware.

During synchronous communication between the client and aggregation engine, the client calls the aggregation engine 100 through inbound interface 110, waits for the aggregated output, and then processes that output received through outbound interface 150 as desired. During an asynchronous communication, the client can store the demands until communication is established with the aggregation engine 100. Demands are then sent to the aggregation engine through inbound interface 110 where they are aggregated and output through outbound interface 150 back to the client (or another recipient) according to predetermined controlling parameters.

Demand processor 120 processes the demands into groups according to the applicable aggregation rule. Aggregation rules will be discussed in more detail below.

Group builder 130 compares an incoming demand with already existing groups. If the incoming demand fits into a group according to the aggregation rule, the appropriate group ID is assigned to this demand. If the incoming demand does not fit into an existing group, a new group is created and a new group ID is assigned to the demand.

Rule engine 140 builds the aggregation rule from the controlling parameters received. Due to changing customer requirements, the rule engine must permit clients to easily amend rules. Different possible aggregation rules are discussed in more detail below.

Outbound interface 150 outputs the demands with a group ID to the client. This group ID information can be analyzed by the client if desired. One such client could be a demand aggregation application on an electronic commerce system so as to enable the creation of coalitions based on a group of demands. As used herein, a coalition is a list of product or service descriptions with additional information like order unit or delivery date and with some global administration data like classification, start and close data. As a result of the coalition creation in the demand aggregation application, the aggregation engine 100 receives a coalition ID. Preferably, the demand aggregation application should also be able to send existing coalition items to the aggregation engine 100. If requested, a coalition of members in the demand aggregation application can be created automatically.

The concept of an aggregation rule is now further discussed. An aggregation rule is the set of criteria used to group demands together. An aggregation rule generally consists of a central theme, such as group by product ID, and additional restrictions. Other examples of central themes are set forth below during a detailed discussion of different types of aggregation rules. Examples of additional restrictions that could be used with any type of aggregation engine rule include: 1) demands must have the same ship-to address; 2) demands must have the same ship-to party; 3) demands must have the same billing address; 4) demands must have dates within a predetermined time range, such as a desired delivery date; 5) demands must be from the same source; 6) demands must seek products from the same source. Other additional restrictions can be utilized and will become apparent to users and developers of such a system. An aggregation rule should consist of the following: 1) a list of attributes of the demand, 2) for each attribute, an operator (for example “=”), that is used for determining the group and 3) an operator to link the different attributes. An aggregation rule may contain either allowed value(s) or value ranges.

Different types of aggregation rules can be created by an administrator. One example mentioned above is a product ID aggregation rule. With such a rule, demands with the same product ID are grouped together. Another type of rule is a classification-based rule. With a classification-based rule, demands with the same classification or a similar classification are grouped together.

In some cases, you may want to group together a set of classifications in a certain hierarchical fashion. In order to do so, the aggregation engine would need multiple values or an interval of values for at least one attribute. Thus, it should be possible for the client to define some number range or interval for the classification when programming the aggregation rule.

One classification system that would preferably be supported by the aggregation engine would be the UN/SPSC classification. The UN/SPSC classification schema is a widely accepted system. UN/SPSP classifications appear in various electronic trade documents such as product catalogs, websites and other computer applications. This system is a hierarchical 5-level system permitting “drill down” and “roll up” analysis. These 5 levels include segment, family, class, commodity and business function. Each level contains a two-character numerical value and a textual description. The fifth level (business function) can indicate business relationship to the supplier such as rental/lease, retail or original equipment manufacturer.

Another classification system that should be supported is the eclass schema. Eclass was developed by leading German companies and is characterized by a 4-level hierarchical classification and the integration of attribute lists for the description of product and service specifications.

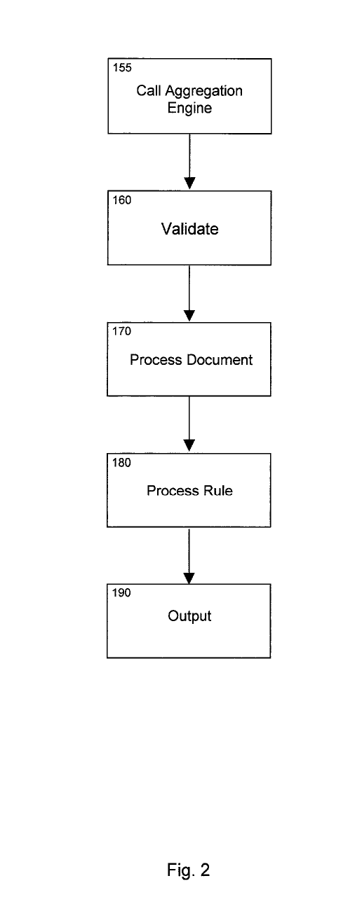

The process undertaken by an aggregation engine according to an embodiment of the present invention is shown in FIG. 2. The aggregation engine could be implemented through the Java classes as discussed with reference to the figure. In step 155, the aggregation engine is called by the client. This call could be made using a method aggregate (string), which could be the main interface to the client to the main class for the aggregation engine, AggregationEngine.

In step 160, the incoming data is validated. This could be accomplished through a class called XMLValidator, which is a helper class to check if the XML data is valid. A method of validateXML can be used to check the given XML against the schema.

In step 170, the incoming XML document is processed to extract the demands to be aggregated and the aggregation rule. This could be accomplished through an XMLProcessor class, which extracts information from the XML and creates the rule object, the aggregateeformat object and the aggregatee object. Methods that could be used could be ProcessDocument(document) which would parse the XML document and set the values of the aggregatee and agregateeformat and the rule objects and ProcessElement(Element) which would support the processDocument method.

The class Rule has the variables RuleID:int and RuleTermList:vector. RuleTerm represents a structure of rule attribute. Every attribute has a Name, Type, Operation, Logical Operator. The variables for this class include ruleType:String; attrName:String; attrType:String; attrValue1:String; attrValue2:String; and attrOp:String.

Aggregatee is an aggregation engine representation of an object to be aggregated. This can be a shopping basket item, coalition item from a demand aggregation application, or any other object satisfying the aggregatee interface. Aggregatee objects have a name, type and value. These are stored in a hashtable in an Aggregatee object. A variable for this class could be value:String. AggregateeAttribute represents a single element from Aggregatee. A variable that could be used is value:String. AggregateeFormatList has a variable AggregateeFormatList:vector. AggregateeFormat has the variables Name:String and Type:String.

Once the rule and demands have been extracted from the incoming data, the rule is processed and the demands are analyzed against the rule, as shown in step 180. This can be accomplished through a method called processJ2X of AggregationEngine. This method loops over each aggregates and calls the class AbstractRuleProcessor. AbstractRuleProcessor forms an interface to represent a rule processor. It has the method processRule(Aggregatee) which is implemented by the RuleProcessor class. The RuleProcessor class analyzes the rule. The method processRule(Aggregatee) takes the aggregatee and applies the rule and finds the terms for each aggregatee. It matches the aggregatee terms with the groups available from GroupList and assigns the aggregatee object to the selected group. If no group is found, it creates a new group and assigns the aggregatee to this group.

GroupList is a collection of groups with the variable GroupList:vector. Group is a collection of aggregatees based on a specific rule. Every group has a list of terms that defines the conditions to join the group. The variables include GroupId:int, aggregateeList:vector, and termList:vector. Term represents a condition to join the group. The variables include name, type, value1, value2 and operator. TermList includes the variable TermCollection.

In step 190 the groups created by the aggregation engine are converted to an appropriate format (for instance, XML) and output to the client. This can be accomplished through the returnOutboundXML method of AggregationEngine including a variable outboundXML:String.

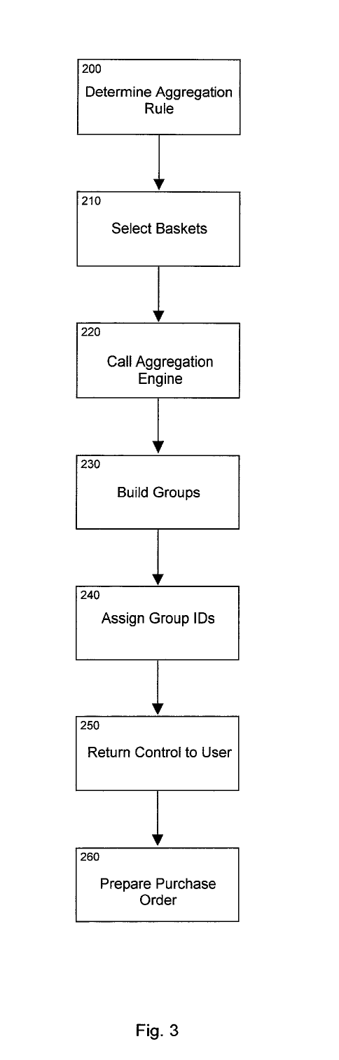

In an electronic commerce system according to an embodiment of the present invention, the need arises to enable the interruption of the automatic creation of purchase orders or RFQs after creating or releasing a shopping basket. In such a system, instead of creating a shopping basket and purchase order in one step, the process would separate those steps as shown in FIG. 3. In step 200, an aggregation rule would be created. In step 210, the user starts a report to select a set of shopping baskets. In step 220, the aggregation engine is called. Then in step 230, the aggregation engine processes the data, and builds groups of shopping baskets according to the aggregation rule, such as grouping shopping baskets with the same product ID, same ship-to-party and same month of delivery. In step 240, the aggregation engine assigns a group ID to each group of shopping baskets and updates an interface table to reflect the group ID. In step 250, control is given back to the caller. The result might be reviewed by the user and should be stored in the shopping basket item. In step 260, the electronic commerce system prepares a purchase order based upon the group ID and other restrictions.

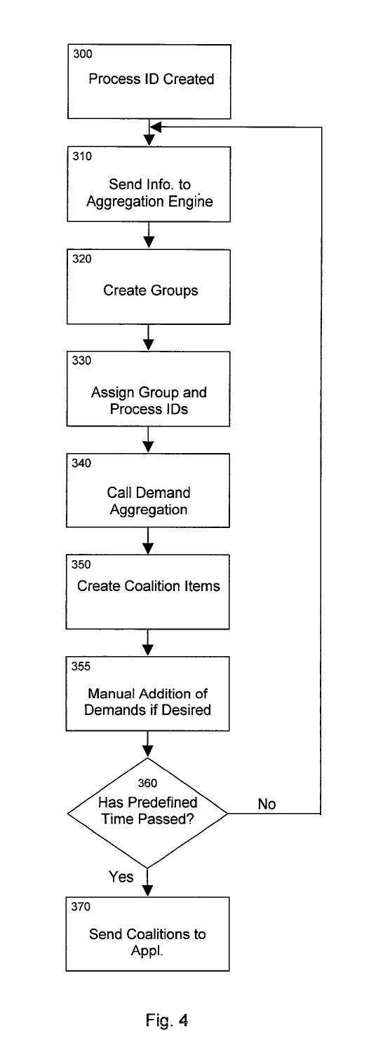

Referring now to FIG. 4, the flow of the process undertaken by an aggregation engine together with a demand aggregation application on an electronic marketplace using a classification-based rule according to an embodiment of the present invention is discussed. In the process shown, demands from a number of different external systems, as well as some manually input into the demand aggregation application are collected. These are forwarded to the aggregation engine for aggregation. At the end of a predetermined time period, for example a week, all coalitions are closed and processed.

In step 300, an aggregation process is started and a process ID is created so as to identify which aggregation rule was utilized in their creation. In step 310, the demands, including classification information, are sent to the aggregation engine. In step 320, the aggregation engine creates a group for each new classification. The aggregation engine then assigns the group ID and the process ID to the demands as shown in step 330.

In step 340, the demand aggregation application on the electronic marketplace is called to create buying coalitions and assign the demands to the coalitions. In step 350, the demand aggregation application creates a coalition item for each group ID. All the demands with a specific group ID are combined in a respective coalition item. In step 355, a user is permitted to enter demands manually into the demand aggregation application and add the demands to one of the existing coalitions.

In step 360, it is determined if a predetermined time period has passed. If it has not yet passed, further demands can be sent to the aggregation engine as shown in step 310. Such demands will be given the same aggregation process ID. For these further demands, if a coalition already exists into which demands fit, they will be added to that coalition unless the coalition has been closed manually. If a coalition does not yet exist, a new one will be created.

If the predetermined time period has expired, the coalitions are automatically closed, if they have not already been closed manually, and they are then sent on to another application, such as a create purchase order application or a create RFQ application as shown in step 370.

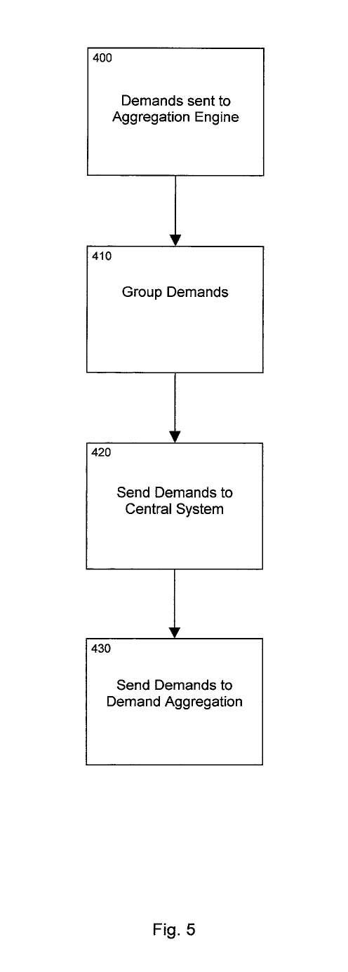

An aggregation process according to another embodiment of the present invention is shown in FIG. 5. In step 400, a number of different procurement systems send demands to aggregation engine 100. The demands could be in the form of shopping baskets, partially complete purchase orders, or in some other form. A standard interface (such as inbound interface 110) is needed to collect these different demands. In step 410, these demands are then consolidated and grouped together according to an aggregation rule, as discussed above. In step 420, the demands are passed on to a central procurement system for further processing, such as generating a purchase order. Rather than generating a purchase order, these groups could be sent to a demand aggregation application on an electronic marketplace to be combined with further demands as shown in step 430. In the demand aggregation application a client can add or modify the data, start the aggregation process again with different parameters or start follow-on functions like shopping basket creation in a procurement system or opportunity creation in a dynamic pricing engine.

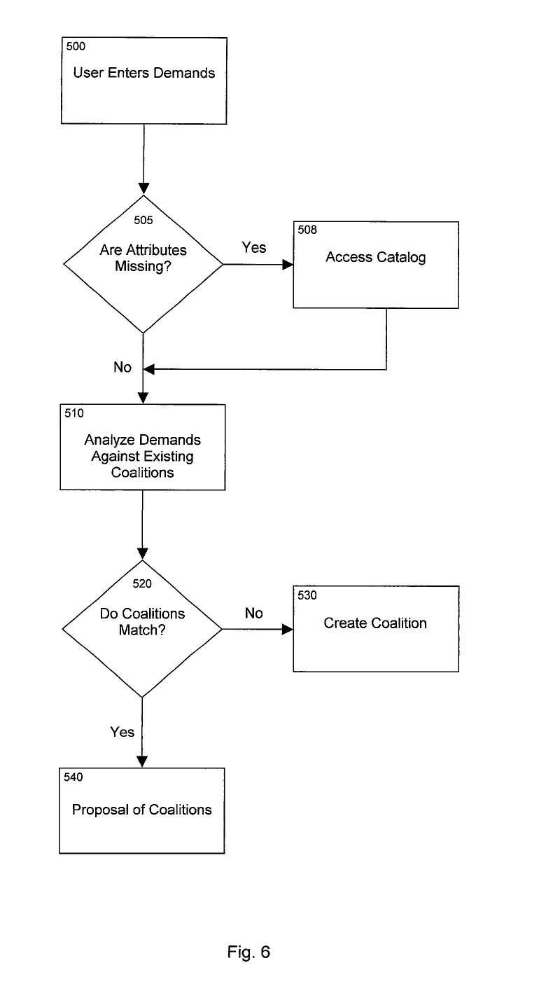

In FIG. 6, a process of utilizing an aggregation engine according to another embodiment of the present invention is shown. In step 500, a user manually enter demands in to the demand aggregation application on an electronic marketplace. After entering all the demands, as shown in step 505, the system determines if any attributes of the demands are missing. If there are any missing attributes, a catalog is accessed and the missing attributes are retrieved to as shown in step 508. These steps, 505 and 508 can be also be included in the other embodiments set forth herein if so desired.

In step 510, the demands are analyzed against existing coalitions through the use of an aggregation engine. In step 520, it is determined if each of the demands match the criteria of one or more existing coalitions. If there is no match for a demand, a new coalition is automatically created in step 530 to accommodate the new demand. In step 540, if a demand matches the criteria for one or more existing coalitions, the system proposes those coalitions of members of the electronic marketplace that user can join for each demand item.

Although the preferred embodiments of the present invention have been described and illustrated in detail, it will be evident to those skilled in the art that various modifications and changes may be made thereto without departing from the spirit and scope of the invention as set forth in the appended claims and equivalents thereof.

What is claimed is:

1. An aggregation engine for use in aggregating demands according to an aggregation rule comprising:
a demand processor, said demand processor being outfitted so as to process demands into groups based upon said aggregation rule;
a group builder, said group builder being outfitted so as to compare incoming demands to existing groups, if one of said demands matches one of said existing groups, assigning a group ID to said one of said demands that is associated with said one of said existing groups, if said one of said demands does not match any of said existing groups, creating a new group and assigning a new group ID associated with the new group to said one of said demands; and
a rule engine, said rule engine being outfitted so as to build said aggregation rule according to predetermined parameters.

2. An aggregation engine according to claim 1, wherein said aggregation rule is a product ID rule.

3. An aggregation engine according to claim 1, wherein said aggregation rule is a classification-based rule.

4. An aggregation engine according to claim 3, wherein said aggregation rule supports a UN/SPSC classification.

5. An aggregation engine according to claim 3, wherein said aggregation rule supports an eclass classification.

6. An aggregation engine according to claim 3, wherein said aggregation rule supports hierarchical classifications.

7. An aggregation engine according to claim 1, wherein said aggregation engine receives said predetermined parameters from another application.

8. An aggregation engine according to claim 7, wherein said another application comprises a demand aggregation application.

9. An aggregation engine according to claim 7, wherein said aggregation engine receives said predetermined parameters in an XML-based format.

10. An aggregation engine according to claim 1, wherein said aggregation engine converts units of said demands prior to outputting said groups to another application.

11. A process of aggregating demands comprising the steps of:
validating incoming data so as to ensure said data is valid;
processing said incoming data so as to extract an aggregation rule and at least one demand;
processing said aggregation rule so as to apply said aggregation rule against said at least one demand to create at least one group based upon said aggregation rule;
outputting output data indicative of said at least one group.

12. A process of aggregating demands as in claim 11, wherein said incoming data is XML based.

13. A process of aggregating demands as in claim 12, wherein said output data is XML based.

14. A process of generating purchase orders through the aggregation of shopping baskets of demands comprising the steps of:
selecting said shopping baskets to be aggregated;
building groups of said shopping baskets based upon an aggregation rule;
assigning a unique group ID for each of said groups;
storing said group IDs;
generating at least one purchase order based upon at least one of said group IDs.

15. A process of generating purchase orders as in claim 14, further comprising the step of determining said aggregation rule to be applied to said shopping baskets.

16. A process of generating purchase orders as in claim 14, further comprising the steps of:
determining if any attributes of said demands within said shopping baskets are missing; and
if said attributes are missing, acquiring said attributes from another source.

17. A process of creating coalitions of demands comprising the steps of:
creating a process ID to identify a process through which said coalitions are to be created;
creating groups of demands based upon an application of an aggregation rule;
assigning a unique group ID for each group created and assigning said process ID to said demands;
assigning said demands to said coalitions based upon said group IDs;
once a predetermined time period has passed, closing said coalitions.

18. A process of creating coalitions of demands as in claim 17, further comprising the step of permitting manual addition of additional demands to said coalitions.

19. A process of creating coalitions of demands as in claim 17, further comprising the step of permitting coalitions to be manually closed prior to said predetermined time period passing.

20. A process of creating coalitions of demands as in claim 17, wherein said aggregation rule is a classification-based rule.

21. A process of creating coalitions of demands as in claim 17 further comprising the steps of:
determining if any attributes of said demands are missing; and
if said attributes are missing, acquiring said attributes from another source.

22. A process of grouping demands manually input into a system by a user into coalitions of demands comprising the steps of:
inputting demands into a demand aggregation application;
analyzing said demands by applying an aggregation rule;
if said analysis of said demands indicates that said demands meet criteria of one or more of said coalitions, proposing said one or more of said coalitions to said user;
permitting said user to assign said demands to said one or more of said coalitions;
if said analysis of said demands indicates that said demands do not meet criteria of one or more of said coalitions, automatically creating a new coalition to accommodate said demands.

23. A process of grouping demands as in claim 22, further comprising the steps of:
determining if any attributes of said demands are missing; and
if said attributes are missing, acquiring said attributes from another source.

24. A process of aggregating demands according to an aggregation rule comprising the steps of:
collecting demands from a plurality of sources;
creating groups of demands based upon an application of said aggregation rule;
forwarding said demands to a demand aggregation application.

25. A process of aggregating demands as in claim 24, further comprising the steps of:
determining if any attributes of said demands are missing; and
if said attributes are missing, acquiring said attributes from another source.
